(19) United States
(12) Patent Application Publication
(10) Pub. No.: US 2013/0048712 A1
(43) Pub. Date: Feb. 28, 2013

(54) NAGRAID INFORMATION CARD

(71) Applicants: Philippe Guillaud, Los Angeles, CA (US); Cyril Lalo, Los Angeles, CA (US)

(72) Inventors: Philippe Guillaud, Los Angeles, CA (US); Cyril Lalo, Los Angeles, CA (US)

(21) Appl. No.: 13/216,510

(22) Filed: Aug. 24, 2011

(51) Int. Cl. G06Q 40/00; G06Q 20/00; G06K 19/073

(52) U.S. Cl. 235/379; 235/492; 235/380

(57) ABSTRACT

An electronic information card for retrieving information pertaining to a banking account of a user is disclosed. The electronic information card comprises a casing having a front surface and a rear surface, a payment chip and a memory chip located inside the casing, a touch keypad located on the front surface, a display screen located on the front surface and an activate button located on the front surface. The payment chip initiates transaction between the user and the transaction terminal. The memory chip allows the user to access financial services such as checking account balance, checking monthly expenses, checking transaction information in an offline mode by navigating through the touch keypad. The display screen displays information pertaining to the banking account when a user navigates through the touch keypad. The electronic information card provides an enhanced security to the user while making online transactions.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to electronic information cards, and more particularly to an improved electronic information card capable of providing financial information and messages to a user.

### DISCUSSION OF RELATED ART

Electronic payment cards are widely used by people for making financial transactions. These cards may be credit cards or debit cards which can be conveniently used to make financial transactions and purchases, including purchases over the Internet. Not only are they convenient for the user, but banking institutions and commercial shops prefer the user to make financial transaction with these payment cards. Most of the existing cards make use of a magnetic strip on their reverse side for storing information such as the password associated with the user's bank account. Some of these cards make use of Integrated Circuit chip (IC chip) technology to store the password and the transaction information.

The main problem associated with the use of these cards is the difficulty in retrieving information regarding payments, monthly expenses and online transactions. Currently the user must retrieve the transaction information by logging into an online banking account or wait for the transaction statement to be delivered by mail, e-mail, or text message. Today's electronic payment cards do not combine the financial information and Asynchronous Transfer Mode (ATM) applications in a single card.

U.S. Pat. Application No. 20110047038 entitled to Halevi on Feb. 24, 2011, describes a smart credit card device for allowing its owner to safely make credit transactions. This smart credit card comprises a display screen; a memory for storing permanent data in the device; the unique storage of temporary data regarding an impending, specific transaction; a wireless transceiver for establishing data communication with the credit card company through a point of sale; input components for allowing the owner to input data essential for performing a transaction; a processor for controlling the operation of the card device; and a power source for supplying DC power to the card device. However, the smart credit card device requires the user to request a temporary code number for each transaction. Further, the card does not provide the transaction information such as account balance or expenses for the user to reference at anytime as needed.

One prior art, taught in U.S. Pat. No. 7,533,828 issued to Ong on May 19, 2009, discloses an Electronic Credit Card (ECC) that enables transmission/reception of data and/or digital information to/from a host computer via a Terminal Station (TS). The ECC comprises a user verification means; a means for generating a unique transaction identifier; a means for storing the user's account details; a display unit that provides visual information; and a means for communicating with a transaction station to provide account details for the user. The transaction station provides the latest financial information including balances on its information display unit. The user verification means includes a keypad for entry of a personal identification number (PIN). The electronic credit card also includes an enter/confirmation button and an audio transducer for providing an audible sound to activate a financial transaction via telephone. However, this electronic credit card cannot provide messages such as sales promotions from the card issuing company to the user. Further, the card does not have the capability to provide a password for facilitating online transactions.

Another prior art taught in U.S. Pat. No. 5,857,079 issued to Claus on Jan. 5, 1999, discloses a smart card that allows for the categorization of expenses at the time they are incurred and the automatic generation and storage of information concerning the date, payee, and amount of the transaction. This smart card is utilized to record and categorize transactions as they occur by transaction identities. These transaction identities are business or personal classifications, cash, check, or credit card type transactions, and expense categories. This smart card has an alphanumeric display and a keyboard for selecting the class, type, and category. These items are selected by the entry of numbers on the keyboard and textual information is displayed to identify these items in response to the entered numbers. A program in a personal computer is used to specify the class, type, and categories along with the textual information in the smart card via a smart card reader. However, the smart card requires a smart card reader to read and write the information in the smart card which can be time consuming to the user. Such a card does not have the facility to provide a password for the user to protect online transactions.

Therefore, there is a need for a device that can offer a wide range of financial services, such as checking account balance, monthly expense information in an offline mode to the user at the touch of a fingertip. Such a needed device would be able to provide enhanced security to the user while making online transactions. The device would not require a card reader for reading or writing the data on the card. Moreover, such a card would be capable of receiving messages from the card issuing company. The present invention accomplishes these objectives.

### SUMMARY OF THE INVENTION

The present invention is an electronic information card for retrieving information pertaining to a banking account of a user. The electronic information card comprises a casing having a front surface and a rear surface, a payment chip located inside the casing and operatively accessible at the front surface, a memory chip located inside the casing, a touch keypad located on a bottom left portion of the front surface, a display screen located on a top right portion of the front surface and an activate button located on a bottom right portion of the front surface. The display screen displays information pertaining to the banking account when the user navigates through the touch keypad. The information pertaining to the banking account may include transaction information, financial information and messages.

The electronic information card may be a credit/debit card. The payment chip initiates a transaction between the user and the transaction terminal. The memory chip listens to the transaction between the payment chip and the transaction terminal, filters and saves the relevant transaction information in the memory. The electronic information card may be activated by switching on the activate button when used offline. The memory chip allows the user to access financial services such as checking account balance, checking monthly expenses, checking transaction information, conducting online transactions and making fund transfers by navigating through the touch keypad.

The touch keypad includes a plurality of touch buttons. Each of the plurality of touch buttons is capable of providing the financial information such as balance, expenses, transaction information, One Time Password (OTP), Pin Try Counter (PTC), Application Transaction Counter (ATC) and messages to the user. The memory chip is capable of managing the touch keypad and the display screen. The display screen displays the financial information, the transaction information, the OTP and the messages to the user. The user can use the OTP displayed on the display screen along with a username and password, while accessing the online banking account.

The present invention provides an improved information card for storing and displaying information pertaining to the banking account of the user. Such a card provides an enhanced security to the user while making online transactions. Further, the card is portable. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a pictorial view of an electronic information card;

FIG. 2 is a drawing illustrating a flow of transaction performed by the electronic information card;

FIG. 3 is a functional block diagram of the electronic information card;

FIG. 4 is a flow chart illustrating a method for performing a financial transaction by a user utilizing the electronic information card; and

FIG. 5 is an operational flow chart illustrating a method for retrieving financial information pertaining to a banking account of a user in an offline mode utilizing the electronic information card;

### DETAILED DESCRIPTION OF THE PREFERRED EMBODIMENT

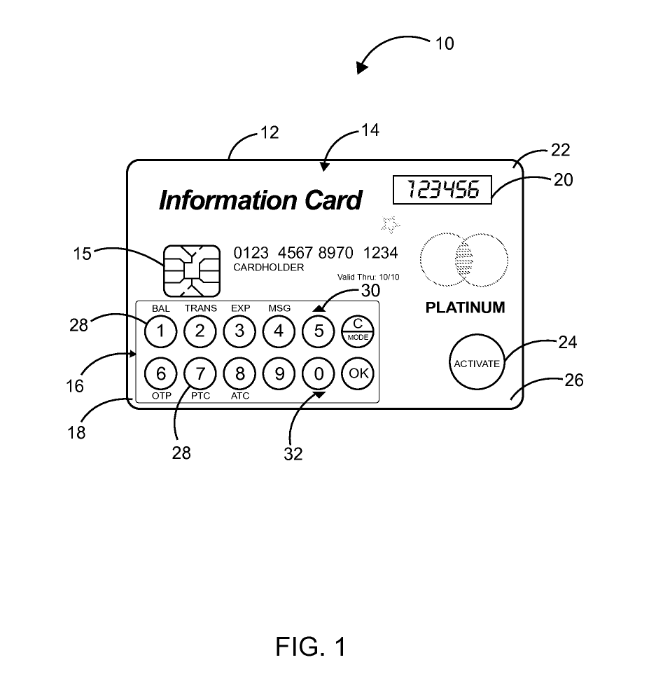

FIG. 1 is a pictorial view of an electronic information card 10 for retrieving information pertaining to a banking account of a user (not shown). The electronic information card 10 comprises a casing 12 having a front surface 14 and a rear surface (not shown), a payment chip 15 located inside the casing 12 and operatively accessible at the front surface 14, a memory chip (not shown) located inside the casing 12, a touch keypad 16 located on a bottom left portion 18 of the front surface 14, a display screen 20 located on a top right portion 22 of the front surface 14 and an activate button 24 located on a bottom right portion 26 of the front surface 14. The display screen 20 displays information pertaining to the banking account when the user navigates through the touch keypad 16. The information pertaining to the banking account may include transaction information, financial information and messages.

The electronic information card 10 may be a credit/debit card. The electronic information card 10 may be accessed using a Personal Identification Number (PIN) associated with the banking account of the user. The electronic information card 10 may be activated by switching on the activate button 24 when used in offline mode. The memory chip (not shown) allows the user to access financial services such as checking account balance, checking monthly expenses, checking transaction information, conducting online transactions and making fund transfers by navigating through the touch keypad 16. The touch keypad 16 includes a plurality of touch buttons 28. The plurality of touch buttons 28 may be twelve in number. The plurality of touch buttons 28 includes buttons such as “BAL” button (1), “TRANS” button (2), “EXP” button (3), “MSG” button (4), “OTP” is button (6), “PTC” button (7), “ATC” button (8), “C/MODE” button, “OK” button and the like. The “C/MODE” button acts as the select button. The “C/MODE” button prompts the user to choose at least one function provided by each of the plurality of touch buttons 28. When the user presses the “C/MODE” button, a “SELECT” message will be displayed on the display screen. The user can select at least one function provided by each of the plurality of touch buttons 28 within three seconds duration.

The “BAL” button (1) is operated by the user to check the current balance in the account. By pressing the “BAL” button (1), a “BAL” message is displayed on the display screen 20 for one second duration. The “BAL” message is then followed by the balance amount which may be displayed for a period of five seconds. The “TRANS” button (2) provides details of each transaction performed by the electronic information card 10. First, a “TRANS” message will be printed on the display screen 20 for one second. Then, each transaction is displayed with the transaction number, transaction amount, date of purchase and transaction type for one second duration and result of the transaction will be displayed for five seconds on the display screen 20. The user can retrieve the details of up to five transactions using the “TRANS” button (2). After checking the transaction details of current transaction, the user may press the “OK” button to go to the next field. The up arrow 30 allows the user to go to the next transaction and the down arrow 32 allows the user to scroll to the previous transaction performed.

The “EXP” button (3) provides the monthly expenses of the user. By selecting the “EXP” button (3), an “EXP” message followed by the expense amount will be displayed on the is display screen of the electronic information card 10 for five seconds. The “MSG” button (4) provides messages contained in the electronic information card 10 to the user (not shown). The messages may be received by the user from the card issuing company. When the user selects the “MSG” button (4), a message “MSG” may be displayed on the display screen 20 for one second and the message will be scrolled across the display screen for 2 seconds. Otherwise a message “NO MSG” will be printed on the display screen 20 for five seconds. The memory chip (not shown) can store up to five messages in the memory. The user can retrieve the next message by pressing the “OK” button. The user can also scroll to the next message using the up arrow 30 and scroll to the previous message using the down arrow 32.

The “OTP” button (6) is operated by the user (not shown) to retrieve a one-time password for performing online transactions. An OTP may be provided to the user after entering the PIN in the electronic information card 10. The user may use the OTP along with a username and password while making online transactions. The OTP may be a six digit number. The “PTC” button(7) provides a pin transaction counter i.e., if the user enters a wrong PIN in the card, the “PTC” function indicates the number of times the incorrect PIN is permitted before the electronic information card 10 gets blocked. The “PTC” message will be displayed for one second and the “Amount” message will be displayed for five seconds on the display screen 20. The “ATC” button (8) provides an application transaction counter to the user. The application transaction counter indicates the number of transactions performed by the electronic information card 10. The ATC is incremented by one for each generation of the OTP. By selecting the “ATC” button, an “ATC” message will be displayed for one second on the display screen and the “Amount” message will be displayed for five seconds. If the user wants to select any other function in between performing these operations, the user can press the “C/MODE” button and select the desired function. After displaying each of the requested function, the memory chip (not shown) may go to a sleep mode thereby terminating the functions performed by the electronic information card 10 in the offline mode. If the user wants to perform any of the above featured functions, the user may have to again activate the electronic information card 10 by pressing the activate button 24.

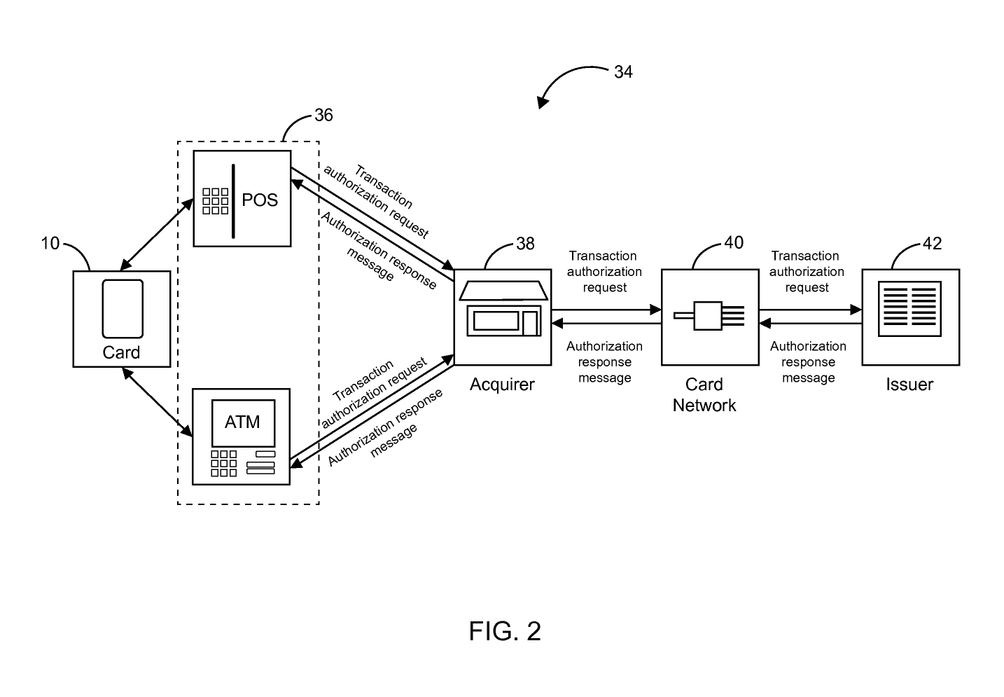

FIG. 2 is a drawing illustrating a flow of transaction 34 performed by the electronic information card 10. Everytime the electronic information card 10 is used in a transaction terminal 36, the transaction authorization request is sent to an acquirer 38 by the transaction terminal 36. The transaction terminal 36 may be selected form a group consisting of Asynchronous Transfer Mode (ATM) terminal and a Point of Sale (POS) terminal. The acquirer 38 may be a merchant, a merchant acquirer or a terminal driver. The payment chip 15 initiates a transaction between the user and the transaction terminal 36. The payment chip 15 may be an Europay Master Card and Visa chip. The transaction authorization request is then routed from the acquirer 38 to an issuer 42 via a card network 40. The issuer 42 receives the request and replies back to the transaction terminal 36 by sending an EMV script as part of an authorization response message. The issuer 42 may be a banking institution which issues the electronic information card 10 to the user. The EMV script of the authorization response message is then received and executed by the transaction terminal 36, which uploads the relevant information to the memory chip (not shown) of the electronic information card 10. Standard EMV chip technology is used to update the information everytime the electronic information card 10 is authorized online.

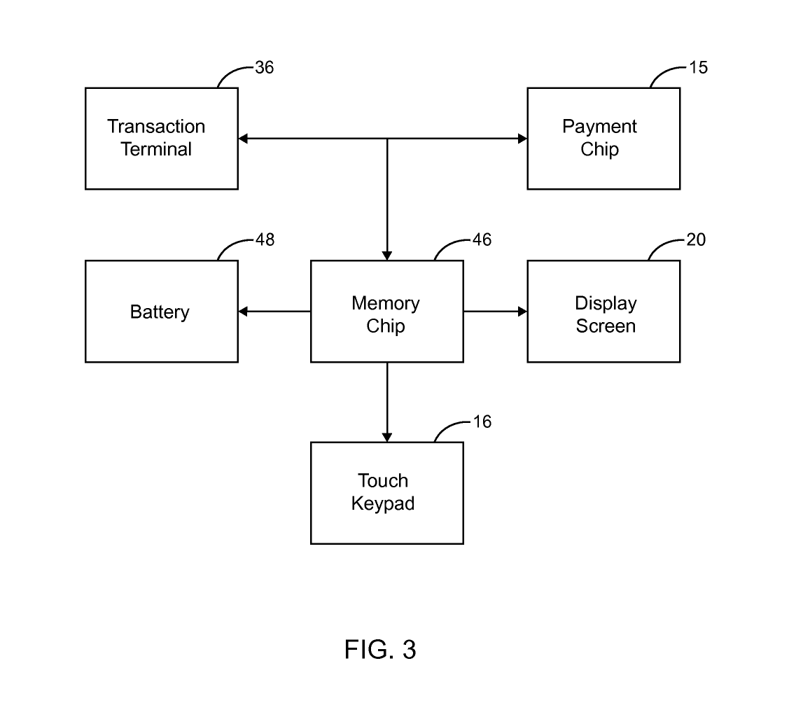

FIG. 3 is a functional block diagram of the electronic information card 10. The user can insert the electronic information card 10 into the transaction terminal 36. The payment chip 15 initiates the transaction between the user (not shown) and the transaction terminal 36. The memory chip 46 then listens to the transaction between the payment chip 15 and the transaction terminal 36, filters and saves the relevant transaction information in the memory. The memory chip 46 is also capable of managing the touch keypad 16 and the display screen 20.

The memory chip 46 is configured to store the information pertaining to the banking account of the user. The information is available at any time to the user by navigating through the touch keypad 16. The memory chip 46 allows the user to access financial services selected from a group consisting of checking account balance, checking monthly expenses, checking transaction information, conducting online transactions and making fund transfers by navigating through the touch keypad 16. The memory chip 46 is also configured to charge battery 48 of the electronic information card 10. The display screen 20 is capable of displaying the financial information, the transaction information, the OTP and the messages to the user. The display screen 20 may be a high contrast numeric Liquid Crystal Display (LCD) screen.

The electronic information card 10 is similar in size to a regular credit/debit card. The casing 12 of the electronic information card 10 may be made of plastic. The electronic information card 10 provides enhanced security to the user while making online transactions. The user can use the OTP displayed on the display screen along with the username and password, when accessing the online banking account. The electronic information card 10 would keep the user safe even if the password was compromised. Since the OTP constantly changes, anyone trying to access the banking account would need to have the electronic information card 10 physically in their possession. Even if the card was lost, the user would still be protected since the username and password would still be required for access. The electronic information card 10 is also user friendly and portable that it can easily fit in a user wallet. The improved level of security and convenience allows the user to access a wide range of financial services, such as checking their account balance, conducting online transactions and making transfers to non-pre-designated accounts at the touch of a fingertip. Context-specific alerts and marketing messages can be delivered to the user from the card issuing company very cost-effectively and easily.

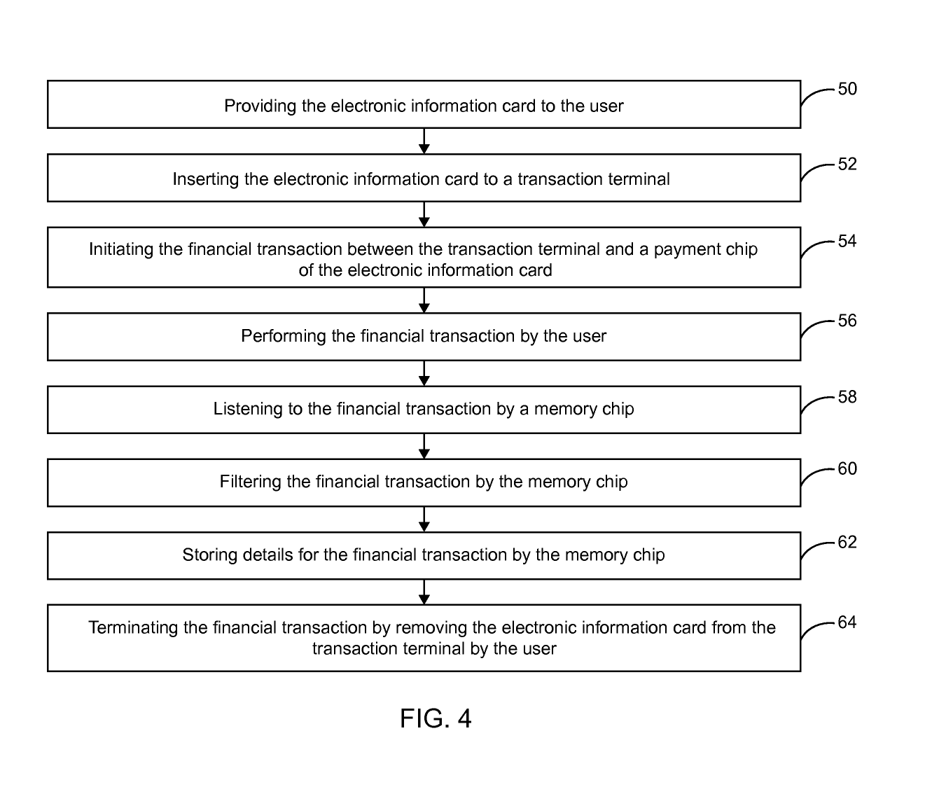

Referring to FIG. 4, a flow chart illustrating a method for performing financial transaction by the user using the electronic information card 10 is illustrated. At first, the electronic information card is provided to the user as indicated at block 50. The electronic information card is then inserted to the transaction terminal as shown in block 52. The financial transaction between the transaction terminal and the payment chip of the electronic information card is then initiated as indicated at block 54. The financial transaction is then performed by the user as shown in block 56. The memory chip may then listen to the financial transaction as indicated at block 58. As shown in block 60, the financial transaction is filtered by the memory chip. The financial transaction is then stored in the memory of the memory chip as shown in block 62. The financial transaction is then terminated by removing the electronic information card from the transaction terminal by the user as indicated at block 64.

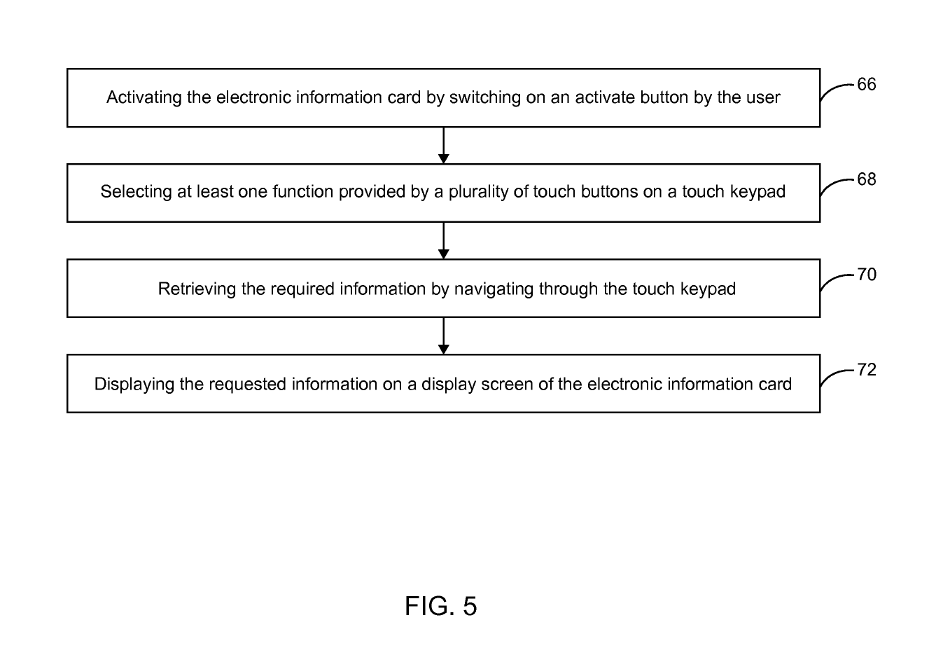

FIG. 5 is an operational flow chart illustrating a method for retrieving financial information pertaining to a banking account of a user using the electronic information card 10 in an offline mode. The electronic information card 10 is activated by switching on an activate button by the user as indicated at block 66. The at least one function provided by the plurality of buttons on the touch keypad is then selected by the user as shown in block 68. The required information is then retrieved by navigating through the touch keypad by the user as indicated at block 70. As shown in block 72, the requested information is displayed on the display screen of the electronic information card.

While a particular form of the invention has been illustrated and described, it will be apparent that various modifications can be made without departing from the spirit and scope of the invention. For example, the touch keypad 16, the display screen 20 and the activate button 24 may be located anywhere on the front surface 14 so as to provide a better appearance to the electronic information card 10. Likewise, the electronic information card 10 may further include an electronic signature facility to provide an enhanced security to the user. Accordingly, it is not intended that the invention be limited, except as by the appended claims.

What is claimed is:

1. An electronic information card for retrieving information pertaining to a banking account of a user, the card comprising:
a casing having a front surface and a rear surface;
a payment chip located inside the casing, the payment chip being operatively accessible at the front surface, the payment chip being configured to initiate transaction between the user and a transaction terminal;
a touch keypad located on the front surface, the touch keypad includes a plurality of touch buttons;
a memory chip located inside the casing, the memory chip capable of storing the information pertaining to the banking account;
a display screen located on the front surface, the display screen configured to display the information stored on the memory chip; and
an activate button located on the front surface, the activate button configured to activate the electronic information card;
whereby the display screen displays the information pertaining to the banking account when the user navigates through the touch keypad.

2. The electronic information card of claim 1 wherein the electronic information card may be a credit/debit card.

3. The electronic information card of claim 1 wherein the information pertaining to the banking account may include transaction information, financial information and messages.

4. The electronic information card of claim 1 wherein the transaction terminal may be selected form a group consisting of: Asynchronous Transfer Mode (ATM) terminal and a Point of Sale (POS) terminal.

5. The electronic information card of claim 1 wherein the memory chip is capable of listening to, filtering and storing the transaction information between the payment chip and the transaction terminal.

6. The electronic information card of claim 1 wherein the electronic information card may be accessed using a Personal Identification Number (PIN) associated with the banking account of the user.

7. The electronic information card of claim 1 wherein each of the plurality of touch buttons is capable of providing the financial information such as balance, expenses, transaction information, one time password (OTP), pin try counter (PTC), application transaction counter (ATC) and messages to the user.

8. The electronic information card of claim 1 wherein the memory chip is capable of managing the touch keypad and the display screen.

9. The electronic information card of claim 1 wherein the memory chip allows the user to access financial services selected from a group consisting of: checking account balance, checking monthly expenses, checking transaction information, conducting online transactions and making fund transfers by navigating through the touch keypad.

10. The electronic information card of claim 1 wherein the payment chip may be an Europay MasterCard and Visa (EMV) chip.

11. The electronic information card of claim 1 wherein the display screen is capable of displaying the financial information, the transaction information, the OTP and the messages to the user.

12. The electronic information card of claim 1 wherein the casing may be made of plastic.

13. The electronic information card of claim 1 wherein the electronic information card is portable.

14. A method for performing financial transaction by a user using an electronic information card, the method comprising the steps of:
a) providing the electronic information card to the user;
b) inserting the electronic information card to a transaction terminal;
c) initiating the financial transaction between the transaction terminal and a payment chip of the electronic information card;
d) performing the financial transaction by the user;
e) listening to the financial transaction by a memory chip;
f) filtering the financial transaction by the memory chip;
g) storing details for the financial transaction by the memory chip; and
h) terminating the financial transaction by removing the electronic information card from the transaction terminal by the user.

15. The method of claim 14 wherein the electronic information card may be a credit/debit card.

16. The method of claim 14 wherein the transaction terminal may be selected form a group consisting of: Asynchronous Transfer Mode (ATM) terminal and a Point of Sale (POS) terminal.

17. A method for retrieving information pertaining to a banking account of a user using an electronic information card in an offline mode, the method comprising the steps of:
a) activating the electronic information card by switching on an activate button by the user;
b) selecting at least one function provided by a plurality of buttons on a touch keypad;
c) retrieving the required information by navigating through the touch keypad; and
d) displaying the requested information on a display screen of the electronic information card.

18. The method of claim 17 wherein the electronic information card may be a credit/debit card.

19. The method of claim 17 wherein the information pertaining to the banking account may include transaction information, financial information and messages.

20. The method of claim 17 wherein each of the plurality of touch buttons is capable of providing the financial information such as balance, expenses, transaction information, One Time Password (OTP), Pin Try Counter (PTC), Application Transaction Counter (ATC) and messages to the user.
